(19) United States
(12) Patent Application Publication
(10) Pub. No.: US 2026/0085969 A1
(43) Pub. Date: Mar. 26, 2026

(54) METHOD AND DEVICE FOR SECURITY OF A LAPTOP ELECTRONIC DEVICE

(71) Applicant: Lenovo (United States) Inc., Morrisville, NC (US)

(72) Inventors: Igor Stolbikov, Apex, NC (US); Scott Li, Cary, NC (US); Robert J Kapinos, Durham, NC (US); Robert James Norton, Jr., Raleigh, NC (US)

(21) Appl. No.: 18/893,442

(22) Filed: Sep. 23, 2024

(51) Int. Cl. G01J 1/02; G06F 21/84

(52) U.S. Cl. CPC G01J 1/0238; G01J 1/0219; G06F 21/84

(57) ABSTRACT

A laptop electronic device is provided that can include a sensor configured to detect third-party cameras, one or more processors, and a data storage device having executable instructions accessible by the one or more processors. Responsive to execution of the instructions, the one or more processors can be configured to monitor an environment for the third-party cameras based on data collected from the sensor, and provide a remedial action in response to detecting at least one of the third-party cameras.

### BACKGROUND

Embodiments herein generally relate to methods and devices for providing secure access to an electronic device.

Electronic devices, such as laptop computers, mobile phones, personal digital assistants (PDAs), iPads, other computing devices, etc. have become part of many individuals’ everyday life. Such electronic devices continue to be improved to make the experience of user as enjoyable as possible. In particular, laptop computers and other similar portable computers have become a staple of the modern day workplace. Such laptop electronic devices provide a worker with the ability to work remotely, work in public places such as coffee shops, airports, playgrounds, while visiting friends or family, or the like.

With the increase of popularity of laptop computers, security related to accessing these devices continues to be a concern. One of the ways that bad actors, or nefarious individuals gain access to files, programs, accounts, login information, etc. is by using hidden cameras that can record screen shots of information, user inputs, or the like. In particular, a nefarious individual may place a camera in a work area, coffee shop, airport, shopping center, or the like in an effort to capture information displayed on an individual’s screen or keystroke information of an individual.

Currently in the marketplace mobile phones can include hardware that can be used to detect third-party cameras within an environment. Similarly, hardware can be provided that is retrofit onto existing electronic devices such as smartphones that can be used to detect a third-party camera. Such technologies must be actuated by a user to begin scanning and detecting whether a third-party camera is within an environment of the mobile phone. This scanning and detecting can only be in use for a period of time until the user stops attempting to detect third-party cameras. In this manner, if a user desires to use a laptop electronic device in public, they must remember to use their mobile phone to provide a scan of the environment before use. As a result, when a user forgets or does not utilize this feature, the laptop electronic device remains susceptible to the third-party cameras. In addition, once the scan is completed and a user begins using the laptop electronic device, the scanning is no longer provided. As a result, if a nefarious individual sees a person scan an environment before using a laptop electronic device the nefarious individual then knows a scan is not taking place while the user uses the laptop electronic device and that the user has information they consider valuable on the display of the laptop electronic device.

Thus, a need exists for improved security for laptop and similar portable devices from hidden cameras.

### SUMMARY

In accordance with embodiments herein, a laptop electronic device is provided that can include a sensor configured to detect third-party cameras, one or more processors, and a data storage device having executable instructions accessible by the one or more processors. Responsive to execution of the instructions, the one or more processors can be configured to monitor an environment for the third-party cameras based on data collected from the sensor, and provide a remedial action in response to detecting at least one of the third-party cameras.

Optionally, the one or more processors can be further configured to obtain context data related to at least one of a user or the environment and activate the sensor configured to detect the third-party cameras based on the context data obtained. In one aspect, the sensor is a first sensor, and the one or more processors can be further configured to obtain context data related to at least one of a user or the environment and activate a second sensor configured to detect the third-party cameras based on the context data obtained. In another aspect, the one or more processors can be further configured to obtain context data related to at least one of a user or the environment and vary a rate by which the sensor obtains data based on the context data obtained. In one example, the sensor can be configured to detect at least one of infrared reflection, a field of infrared illumination, a laser painting of scenes from a three-dimensional depth map sensor, or flicker from strobed illumination.

Optionally, to provide the remedial action can include displaying an alert on a display of the laptop electronic device. In one aspect, the alert can include a location of a third-party camera. In another aspect, to provide the remedial action can include alerting a user via at least one of a visual stimulus or an auditory stimulus. In one example, to provide the remedial action can also include preventing a user of the laptop electronic device from entering information into the laptop electronic device.

In accordance with embodiments herein, a method is provided where under control of one or more processors including program instructions to monitor, with a sensor, an environment of a laptop electronic device for third-party cameras based on data collected from the sensor. The method can also include to provide a remedial action in response to detecting at least one of the third-party cameras.

Optionally, the method can additionally include under control of the one or more processors including program instructions to obtain context data related to at least one of a user or the environment and activate the sensor configured to detect the third-party cameras based on the context data obtained. In one aspect the method can also include under control of the one or more processors including program instructions to obtain context data related to at least one of a user or the environment and activate a second sensor configured to detect the third-party cameras based on the context data obtained. In another aspect, the method can include under control of the one or more processors including program instructions to obtain context data related to at least one of a user or the environment and vary a rate by which the sensor obtains data based on the context data obtained. In one example to provide the remedial action can include displaying an alert on a display of the laptop electronic device. In another example to provide the remedial action can include alerting a user via at least one of a visual stimulus or an auditory stimulus. In yet another example to provide the remedial action may include preventing a user of the laptop electronic device from entering information into the laptop electronic device.

In accordance with embodiments herein a computer program product is provided that can include a non-signal computer readable storage medium comprising computer executable code to automatically monitor, with a sensor, an environment of a laptop electronic device for third-party cameras based on data collected from the sensor and provide a remedial action in response to detecting at least one of the third-party cameras.

Optionally, the computer program product can also include the computer executable code to automatically obtain context data related to at least one of a user or the environment and activate the sensor configured to detect the third-party cameras based on the context data obtained. In one aspect, the computer program product can further include the computer executable code to automatically obtain context data related to at least one of a user or the environment and activate a second sensor configured to detect the third-party cameras based on the context data obtained. In another aspect, the computer program product additionally can include computer executable code to automatically obtain context data related to at least one of a user or the environment and vary a rate by which the sensor obtains data based on the context data obtained.

### BRIEF DESCRIPTION OF THE DRAWINGS

FIG. 1 illustrates an front view of an electronic device in accordance with embodiments herein

FIG. 2 illustrates an front view of an electronic device in accordance with embodiments herein

FIG. 3 illustrates a back perspective view of an electronic device in an environment in accordance with embodiments herein

FIG. 4 illustrates a schematic view of an electronic device in accordance with embodiments herein

FIG. 5 illustrates a schematic block diagram of a process for detecting third-party cameras in accordance with embodiments herein

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment,” “in an embodiment” or the like in various places throughout this specification are not necessarily all referring to the same embodiment.

Furthermore, the described features, structures or characteristics may be combined in any suitable manner in one or more embodiments. In the following description, numerous specific details are provided to give a thorough understanding of the various embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

The term “environment” refers to a physical region in which one or more laptop electronic devices are located and in which an image on a screen of the laptop electronic device or an input device of a laptop electronic device can be captured by a third-party camera. By way of example, an environment may refer to one or more rooms within a home, office or other structure. An environment may or may not have physical boundaries. For example, an environment instead be defined based upon a range over which a third-party camera may capture images or video of the screen or input device of the laptop electronic device. When a laptop electronic device is moved an environment associated with the laptop electronic device shifts over time. For example, an environment surrounding a laptop computer moves with the laptop computer. An environment surrounding a laptop electronic device will shift each time the laptop electronic device is relocated, such as when moved between different rooms of a home, office building or other residential or commercial structure.

The phrase “third-party camera” as used herein refers to any and all devices or systems for recording, filming, capturing, etc. images, data, information that is not a component of a laptop electronic device of a user. In example embodiments the third-party camera can be an infrared camera or sensor, a 3-D depth map sensor, an image sensor including image sensors that have strobed illumination, or the like.

The phrase “context data” shall mean any and all data, information, digital information, images, sounds, noises, etc. obtained from an environment. The context data can be obtained from sensors of an electronic device, sensors of an auxiliary electronic device that is communicated to an electronic device, a storage device of an electronic device or auxiliary electronic device, a determination made from information communicated from an auxiliary electronic device to an electronic device, a determination made from data detected by an electronic device or auxiliary electronic device, data detected by an electronic device or auxiliary electronic device, or the like. The context data can include the number of individuals in an environment, motion data, information and data related to events such as sporting events, concerts, plays, or the like, being observed by an individual, etc., noise level, location data or information, or the like.

The phrase “remedial action” as used herein refers to any action, actuation, activation, etc. that is taken that cures, addresses, solves, protects, or the like a user from a third-party camera. Remedial actions can include alerting a user of the third-party camera, varying functioning of the laptop electronic device including by blacking out a display, preventing a login from loading or being populated, etc., obtaining data or information to identify the third-party camera, or the like.

The phrase “laptop electronic device” as used herein refers to a piece of hardware that can process information, receive inputs, and display outputs that is of size and shape to include a separate display and physical keyboard. The physical keyboard is of size and shape such that it is large enough that an average person can place all of their fingers on separate keys but remains small enough to be considered mobile or portable. For example, a mobile phone, flip phones, smart phone, smart watch, fit bits, or the like are not laptop electronic devices because they either do not include a separate physical keyboard, or the keyboard is not large enough such that an average person can place all of their fingers on separate keys. In addition, desktop computers are not laptop electronic devices because they are too bulky and large to be considered mobile or portable.

The term “obtains” and “obtaining” as used in connection with data signals information and the like include at least one of i accessing memory of an external device or remote server where the data signals information etc are stored ii receiving the data signals information etc over a wireless communications link between a primary electronic device and a secondary electronic device and/or iii receiving the data signals information etc at a remote server over a network connection The obtaining operation when from the perspective of a primary electronic device may include sensing new signals in real time and/or accessing memory to read stored data signals information etc from memory within the primary electronic device The obtaining operation when from the perspective of a secondary electronic device includes receiving the data signals information etc at a transceiver of the secondary electronic device where the data signals information etc are transmitted from a primary electronic device and/or a remote server The obtaining operation may be from the perspective of a remote server such as when receiving the data signals information etc at a network interface from a local external device and/or directly from a primary electronic device The remote server may also obtain the data signals information etc from local memory and/or from other memory such as within a cloud storage environment and/or from the memory of a personal computer.

It should be clearly understood that the various arrangements and processes broadly described and illustrated with respect to the Figures, and/or one or more individual components or elements of such arrangements and/or one or more process operations associated of such processes, can be employed independently from or together with one or more other components, elements and/or process operations described and illustrated herein. Accordingly, while various arrangements and processes are broadly contemplated, described and illustrated herein, it should be understood that they are provided merely in illustrative and non-restrictive fashion, and furthermore can be regarded as but mere examples of possible working environments in which one or more arrangements or processes may function or operate.

A system and processes are provided for securely using a laptop electronic device, including in public settings. One or more camera detecting sensors are utilized that are configured to detect third-party cameras in an environment. A security application is provided that determines when and how often the one or more camera detecting sensors actuate to determine if a third-party camera is within an environment. In one example the laptop electronic device can obtain context data related to the environment of the electronic device and increase monitoring or use of the one or more camera detecting sensors when a determination is made the laptop electronic device is in an environment that is more likely to have a third-party camera than when in an environment that is not more likely to have a third-party camera. In one example artificial intelligence can be used to make the determination of when the laptop electronic device is within such an environment.

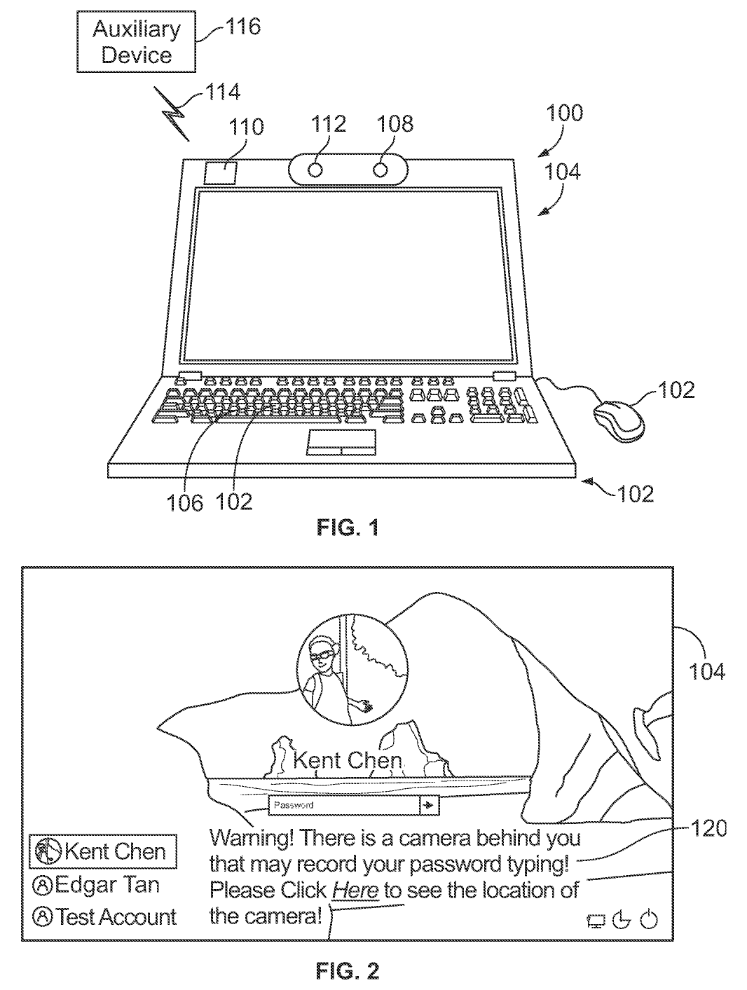

FIG. 1 illustrates an example laptop electronic device 100. The electronic device includes an input device 102 that in this example is a keyboard that is hingedly coupled to a display 104. The input device 102 can be a keyboard as illustrated that can include includes plural keys 106 that each have a key indicator such as “q”, “w”, “e”, “7”, “?”, etc. to provide input device input into the electronic device 100. Each key 106 is of size and shape to allow an average person to place a finger on individual keys.

The laptop electronic device 100 can also include one or more sensors 108, 110, 112 that can obtain data and information from an environment. While in this example three separate sensors 108, 110, 112 are illustrated, in other examples only a single sensor may be provided on the laptop electronic device. The first sensor 108 in one example can be a first third-party camera detecting sensor. For example, the first sensor 108 can be a camera of the laptop electronic device 100 that is configured to capture images of the environment of the laptop electronic device 100. In one example the first sensor 108 can be a sensor that can detect and be used to identify infrared (IR) reflection from a third-party camera. In an example the first sensor can detect a field IR illumination from third-party cameras and camera sensors that may not be in view of the user. In another example the first sensor 108 may detect a laser painting of scenes from 3D depth map sensors. In another example the first sensor 108 may be configured to detect a flicker from strobed illumination on differential image sensors from third-party cameras. In yet another example the first sensor 108 can be configured to combine third-party camera detection with radio frequency (RF) signal detection. In example embodiments the first sensor may function to provide one or more of these functions. In another example the first sensor 108 may be positioned to monitor for third-party cameras that are attempting to capture images or video related to the display 104. Alternatively, the first sensor 108 can be positioned to monitor for third-party cameras that are attempting to capture images or video related to one or more input devices 102. In another embodiment the first sensor may be positioned or movable to monitor for any third-party camera within the environment.

The second sensor 110 in one example can be any of the sensors described in relation to the first sensor 108. In one example the first and second sensors are configured to operate in unison to detect different areas of an environment for third-party cameras. In one example the first sensor 108 may have a field of view configured to detect third-party cameras that can capture or video the display 104 while the second sensor 110 can have a field of view configured to detect third-party cameras that can capture or video one or more input devices 102. In another example the first and second sensors can be configured to detect third-party cameras in similar areas in the environment, but provide different types of detections. For example, the first sensor 108 may detect IR illumination in an environment while the second sensor detects flicker from strobed illumination. In yet another example the first and second sensors 108 and 110 may operate such that the first sensor 108 is always used when monitoring an environment and the second sensor 110 is only used when determined conditions are met. Determined conditions can include a manual input from a user, determination that the laptop electronic device is in a pubic area, detection by the first sensor of a third-party camera, determination that the laptop electronic device is within a determined area, or the like. By using the second sensor 110 only when certain determined conditions are met, battery life of the laptop electronic device can be conserved.

The third sensor 112 in one example can be and function as any of the previously described first sensor 108 and second sensor 110. Alternatively, the third sensor 112 can be configured to detect context data from the user, laptop electronic device, environment, or the like. In one example the third sensor 112 can be a motion detector that detects the presence of third-parties in an environment. In another example the third sensor 112 is a camera of the laptop electronic device 100 that can detect third parties within the environment. In yet another example the third sensor 112 may detect whether numerous public networks exist in an area indicating the user is in a public area. In yet another example the third sensor can be a microphone that can detect noise levels, sounds, or the like that can be used to determine whether the user is within a public environment or if third parties exist within an environment.

The third sensor 112 may detect the context data to make determination related to determined conditions within an environment that can be used to vary the operation and functionality of one or more of the first sensor 108 and/or second sensor 110. For example, the first sensor may provide scanning for third-party cameras at a first rate. In one example the first rate may be one scan for third-party cameras every ten minutes. Upon detection of a determined condition the first rate may be automatically and dynamically changed to a second rate that is faster than the first rate. In an example the first sensor 108 may scan for a third-party camera once every ten minutes; however, upon detection the laptop electronic device is in a public area the rate may be increased to the second rate such that the first sensor scans once every minute. In another example there may be different rates related to different determined conditions in an environment. In the example provided, a third rate of scanning for third-party cameras once every fifteen (15) second may be provided when a third-party camera has been detected. Such rate determination can be provided by one or more processors using a decision tree, lookup table, dynamically calculated, dynamically modeled, or the like.

The laptop electronic device 100 can also include a communication link 114 to an auxiliary electronic device 116. In one example the third sensor 112 and sensors of the auxiliary electronic device 116 may each be configured to obtain context data, where the auxiliary electronic device 112 may communicate the context data to the electronic device via a transceiver. The context data can then be utilized by a security application to determine if individuals other than the user are in the environment, resulting in the varying of the rate at which either one of the first sensor and/or second sensor monitor for third-party cameras.

The context data can include visual data from a camera showing other individuals in an environment, or movements of other individuals in an environment. The context data may also include visual data, location data, a combination of visual data and location data, etc. that may be utilized to determine an electronic device is in a location where other individuals are likely located. Such locations may include schools, office buildings, shopping malls, stores, gyms, classrooms, public parks, libraries, coffee shops, bars, or the like. In other examples, the context data may include sound data and information, including sound received from a microphone. The sound data and information may include background noise, volume levels, voice recognition, or the like. Again, such context data can be utilized to determine whether other individuals are within an environment.

In another example, context data may also include data and information input into the electronic device. For example, a security application of the electronic device may include a physical or touch screen input or prompt requesting to know if other individuals are in the environment, if secure access is desired, or the like. In this manner, a user may input into the device that additional security is desired as a result of other individuals being in an environment.

In yet another example, context data can include information and data stored in a memory, application, etc. To this end, a security application can obtain context data such as calendar information, email or text information or the like, that identifies a location of a user during a determined period of time. In addition, context data may also be received from the auxiliary electronic device, a remote device, a third-party device, or the like, where the auxiliary electronic device obtains the context data, or data or information that can be used to determine context data and communicates the information or data to the electronic device. Context data may also be obtained by haptic sensors, other sensors, etc. that provide data or information that may be utilized to determine if individuals are in an environment other than the user.

The laptop electronic device 100 can use any data, information, input, etc. received from an input, first sensor 108, second sensor 110, third sensor 112, or the like to detect the presence of a third-party camera. Upon detection of the third-party camera, the laptop electronic device 100 can take a remedial action to provide additional security for a user. In one example, as illustrated in FIG. 2, an alert 120 can be displayed on the display 104 that informs the user the third-party camera is an environment. In one embodiment the alert can include information related to where in the environment the third-party camera is being detected. In another example the remedial action may be preventing a user from populating passwords, logins, etc. until the third-party camera is no longer detected. Alternatively other alerts can include a visual stimulus such as a blinking light, a tone or other auditory stimulus or warning, a haptic response, or the like. In another example one of the first, second, or third sensors 108, 110, 112 can be a camera that captures an image of the hidden camera. The captured image may be used to identify a person holding a third-party camera or determine the location of the third-party camera.

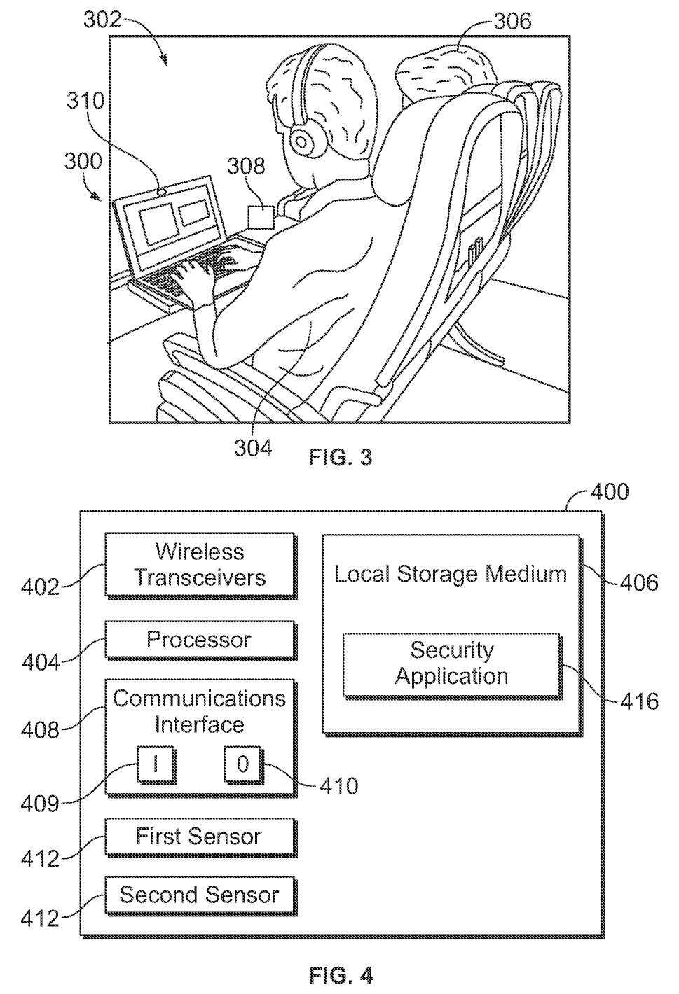

FIG. 3 illustrates an electronic device 300 in an environment 302 where additional security may be desired. In the example, a user 304 is in an airport where several other individuals 306 are seated around the user 304 and can use third-party cameras 308 to record the laptop electronic device. The other individual may alternatively place the camera in a determined location within the environment 302 such as on a seat, on a sign, by a trashcan, on a monitor, on a couch, or the like. The electronic device 300 includes at least one sensor 310 that can be configured to detect the third-party camera. While in the example of FIG. 3 the environment 302 is an airport, in other embodiments the environment may be a store, mall, coffee shop, or the like. In each instance, the user 304 of the electronic device 300 may access an open, or public Wi-Fi network of the store, mall, coffee shop, etc. Consequently, the accessing of the public Wi-Fi network can be context data that results in the security application determining varying the rate at which sensors 310 scan for third-party cameras 308 within the environment 302.

FIG. 4 illustrates a simplified block diagram of a laptop electronic device 400 configured to provide security for the laptop electronic device 400 by detecting the presence of third-party cameras in the environment of the laptop electronic device 400. In one example, the laptop electronic device 400 is the laptop electronic device of FIGS. 1-3. The laptop electronic device 400 includes components such as one or more transceivers 402, one or more processors 404 (e.g., a microprocessor, microcomputer, application-specific integrated circuit, etc.), and one or more local storage medium (also referred to as a memory portion) 406.

The local storage medium 406 can encompass one or more memory devices of any of a variety of forms (e.g., read only memory, random access memory, static random access memory, dynamic random access memory, etc.) and can be used by the one or more processors 404 to store and retrieve data. The data that is stored by the local storage medium 406 can include, but need not be limited to, context data, settings data, application data, operating systems, applications, obtained data, informational data, user characteristics data, environmental characteristics data, etc. Each application and operating system includes executable code that controls basic functions of the device, such as interaction among the various components, communication with external devices via the transceivers 402, and storage and retrieval of applications, context data, etc. to and from the local storage medium 406.

The electronic device 400 in one embodiment also includes a communications interface 408 that is configured to communicate with a network resource. The communications interface 408 can include one or more input devices 409 and one or more output devices 410. The input and output devices 409, 410 may each include a variety of visual, audio, and/or mechanical devices. For example, the input devices 409 can include a visual input device such as an optical sensor or camera, an audio input device such as a microphone, and a mechanical input device such as a keyboard, keypad, selection hard and/or soft buttons, switch, touchpad, touch screen, touch screen keyboard, icons on a touch screen, a touch sensitive areas on a touch sensitive screen and/or any combination thereof. The screen may be touch sensitive to various types of touch and gestures. In one example, the input device 409 may be a touch screen that can present a touchscreen keyboard where when an individual key on the touch screen keyboard is pressed, or touched, an input having the value of the key is inputted into the laptop electronic device. As further examples, the output device(s) 410 may include a non-touch sensitive screen, a text-only screen, an audio output (e.g., a speaker or headphone jack), and/or any combination thereof.

The electronic device 400 may also include one or more electronic device sensors 412 that can obtain environmental data, environmental information, user data or information, context data, or the like. In one example the electronic device sensors 412 include each of the first, second, and third sensors described in relation to FIG. 1. In one example at least one sensor 412 can be configured to detect the presence of a third-party camera in an environment of the electronic device 400. In an example at least one of the sensors 412 can be a camera, infrared camera, or the like that can capture image data in the environment. In another example at least one of the sensors 412 can detect a camera, an infrared field or camera, or the like in an environment. In another example at least one sensor can detect a laser painting of scenes from a 3D depth map sensor, a flicker from strobed illumination, radio frequencies, or the like that indicate a third-party camera is within the environment. In one example the at least one sensor 412 is stationary while in other embodiments a sensor may move relative to the laptop electronic device 400, including rotating about an axis. In an example at least one sensor 412 can obtain context data related to the user or the environment. The at least one sensor can be a microphone, motion detector, Global Navigation System or other location detection sensor, etc. In another example the sensors 412 may continuously detect data, information, or the like. In other examples one or more sensors may only detect data, information, etc. periodically. In some examples the rate at which information and data can be detected by a sensor 412 may dynamically vary, including based on context data or other information or data previously detected.

The laptop electronic device 400 may also include a security application 416. In one example, the security application 416 includes instructions related to obtaining data and information from the sensors 412, processing the information, making determinations regarding how information and data is obtained, determining whether a third-party camera is within an environment of the electronic device, and taking remedial actions related to a detected third-party camera. The security application 416 may provide methods or processes for analyzing data and information obtained by any of the sensors 412. For example, the security application may review data that indicates that infrared signals are within the environment. The security application can analyze the infrared signals to determine if a third-party camera is in the environment, the location of the source of the infrared signals in the environment, whether the infrared signals can detect information or data on a display of the electronic device, etc. The security application also includes instructions related to data and information obtained from the sensors 412 that is context data. Based on the context data the security application can determined whether to begin obtaining information or data using an additional sensor 412, increase the rate at which information is obtained by a sensor, etc. For example, a first sensor of the sensors 412 may detect motion in an environment. Upon a threshold amount of motion being detected, an infrared (second) sensor may automatically be actuated to begin monitoring for third-party cameras. In another example a sensor may be a microphone that detects sounds of a crowded or public area. Upon such detection, the rate at which RFs are detected may dynamically change, or increase from a first rate (e.g., once every five minutes) to a second rate (e.g., once every fifteen seconds). In yet another example the security application 416 may include a personal profile that allows a user of the electronic device to determine rates of monitoring, sensors to be used, or the like and also allows for manual changes to these rates.

In addition, the security application 416 also includes instructions for providing remedial actions once a third-party camera is detected in an environment. In one example an alert or communication can be displayed on the display that a third-party camera has been detected in the environment. In another example the security application 416 may provide additional detail regarding where in the environment the third-party camera is located. In one example the security application may automatically actuate a sensor that is a camera to capture an image of the third-party camera and/or individual holding or using the third-party camera. This image may then be displayed to assist the user in finding the third-party camera. In another example, words on the display can be provided, such as “third-party camera detected over your left shoulder” or “third-party camera detected approximately ten feet behind you”, or the like. In another example the remedial action can be blacking out a display until the third-party camera is no longer detected, preventing login or password information from being presented on a screen, physically locking keys to prevent them from being compressed or actuated, or the like. In another example information related to the electronic device, third-party camera detected, environment, etc. can be automatically stored in a memory, emailed to an email address, etc. This data and information can then be used to attempt to find any individual that is using the third-party camera and attempting to steal and obtain personal information related to the laptop electronic device user.

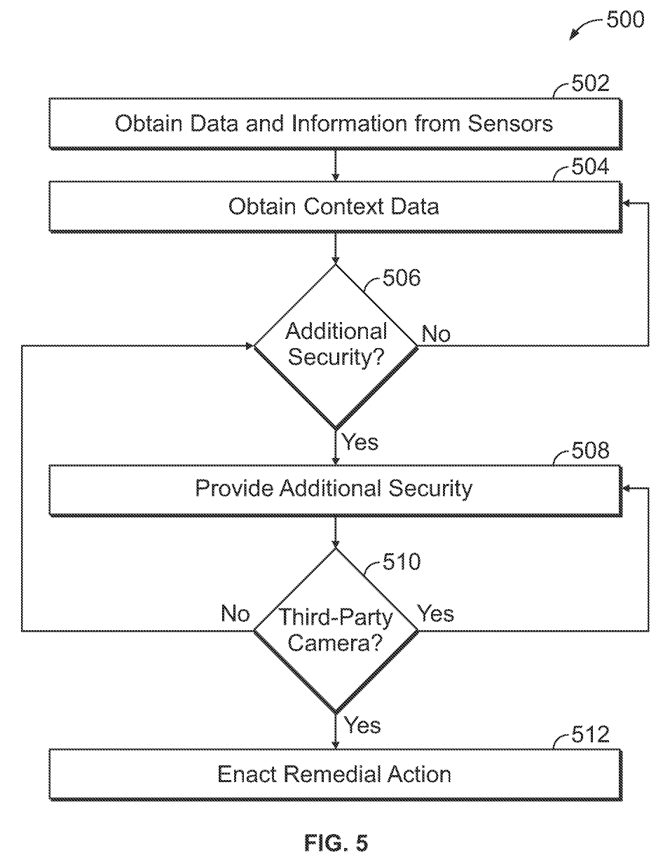

FIG. 5 illustrates a process 500 for providing additional security for a laptop electronic device. In one example, the systems and laptop electronic devices of FIGS. 1-4 are utilized to perform the process.

At 502, one or more processors of a laptop electronic device obtain data and information from one or more sensors related to whether third-party cameras are within an environment. In one example the sensor may be directed to detect the presence of a third-party camera or detect information and data that can be used to determine whether a third-party camera is within an environment. In one example the rate of obtaining the data may occur at a first rate. In another example the electronic device may have numerous sensors configured to detect and determine the presence of a third-party camera, but only a select number of sensors are used to make such determinations to save battery life of the electronic device.

At 504, the one or more processors obtain context data from the laptop electronic device. A security application may be provided that can detect or determine that a login prompt is being displayed on a screen. In one example, the security application can include a profile where a user can input every website, program, application, etc. where additional security may be desired by the user. In another example, the security application is able to identify the login prompt using a mathematical model, algorithm, artificial intelligence algorithm, machine learning algorithm, lookup table, decision tree, or the like. Context data includes any audio, image, movement, operating state, or the like that can be used by the one or more processors to determine if individuals other than the user are in an environment. In one example, the electronic device can include one or more sensors such as cameras, microphones, etc. used to detect the context data. In another example, the context data may be received from another electronic device in the environment and communicated to the electronic device. In yet another example, the context data may include operation in airplane mode, being connected or accessing a publically available network, information and data input by a user, information within a storage device or memory of the electronic device, or the like.

At 506, the one or more processors determine whether additional security is required based on the context data. In one example, the one or more processors may utilize an algorithm, lookup table, decision tree, mathematical algorithm, mathematical model, mathematical function, artificial intelligence algorithm, machine learning algorithm, or the like to make such a determine based on the context data obtained.

If at 506, the one or more processors determine the potential for third-party cameras in an environment is increased, then at 508, the one or more processors provide additional security measures for detecting third-party cameras. In one example additional sensors capable of detecting third-party cameras may be activated. In another example the rate at which data or information is obtained can be increased from a first rate to a second rate. In another example, different sensors can be synchronized such that at least one sensor is continuously monitoring an environment for third-party cameras, or the like.

At 510, the one or more processors determine whether a third-party camera is detected. If not, the increased monitoring continues until a public environment is no longer detected. If a third-party camera is detected, then at 512, the one or more processor can enact remedial measures to address the detection of the third-party camera. The remedial actions can include any of the remedial actions previously described, including alerting a user of the third-party camera in the environment, dynamically preventing or changing functionality of the laptop electronic device to reduce data and information that can be obtained by the third-party camera, capturing images or information about the third-party camera, or the like. By taking the remedial action a practical result of enhanced security is provided for the laptop electronic device.

As will be appreciated, various aspects may be embodied as a system, method or computer (device) program product. Accordingly, aspects may take the form of an entirely hardware embodiment or an embodiment including hardware and software that may all generally be referred to herein as a “circuit,” “module” or “system.” Furthermore, aspects may take the form of a computer (device) program product embodied in one or more computer (device) readable data storage device(s) having computer (device) readable program code embodied thereon.

Any combination of one or more non-signal computer (device) readable mediums may be utilized. The non-signal medium may be a data storage device. The data storage device may be, for example, an electronic, magnetic, optical, electromagnetic, infrared, or semiconductor system, apparatus, or device, or any suitable combination of the foregoing. More specific examples of a data storage device may include a portable computer diskette, a hard disk, a random access memory (RAM), a dynamic random access memory (DRAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection. For example, a server having a first processor, a network interface and a data storage device for storing code may store the program code for carrying out the operations and provide this code through the network interface via a network to a second device having a second processor for execution of the code on the second device.

Aspects are described herein with reference to the figures, which illustrate example methods, devices and program products according to various example embodiments. These program instructions may be provided to a processor of a general purpose computer, special purpose computer, or other programmable data processing device or information handling device to produce a machine, such that the instructions, which execute via a processor of the device implement the functions/acts specified. The program instructions may also be stored in a device readable medium that can direct a device to function in a particular manner, such that the instructions stored in the device readable medium produce an article of manufacture including instructions which implement the function/act specified. The instructions may also be loaded onto a device to cause a series of operational steps to be performed on the device to produce a device implemented process such that the instructions which execute on the device provide processes for implementing the functions/acts specified.

The units/modules/applications herein may include any processor-based or microprocessor-based system including systems using microcontrollers, reduced instruction set computers (RISC), application specific integrated circuits (ASICs), field-programmable gate arrays (FPGAs), logic circuits, and any other circuit or processor capable of executing the functions described herein. Additionally or alternatively, the modules/controllers herein may represent circuit modules that may be implemented as hardware with associated instructions (for example, software stored on a tangible and non-transitory computer readable data storage device, such as a computer hard drive, ROM, RAM, or the like) that perform the operations described herein. The above examples are exemplary only, and are thus not intended to limit in any way the definition and/or meaning of the term “controller.” The units/modules/applications herein may execute a set of instructions that are stored in one or more storage elements, in order to process data. The storage elements may also store data or other information as desired or needed. The storage element may be in the form of an information source or a physical memory element within the modules/controllers herein. The set of instructions may include various commands that instruct the modules/applications herein to perform specific operations such as the methods and processes of the various embodiments of the subject matter described herein. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to user commands, or in response to results of previous processing, or in response to a request made by another processing machine.

It is to be understood that the subject matter described herein is not limited in its application to the details of construction and the arrangement of components set forth in the description herein or illustrated in the drawings hereof. The subject matter described herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

It is to be understood that the above description is intended to be illustrative, and not restrictive. For example, the above-described embodiments (and/or aspects thereof) may be used in combination with each other. In addition, many modifications may be made to adapt a particular situation or material to the teachings herein without departing from its scope. While the dimensions, types of materials and coatings described herein are intended to define various parameters, they are by no means limiting and are illustrative in nature. Many other embodiments will be apparent to those of skill in the art upon reviewing the above description. The scope of the embodiments should, therefore, be determined with reference to the appended claims, along with the full scope of equivalents to which such claims are entitled. In the appended claims, the terms "including" and "in which" are used as the plain-English equivalents of the respective terms "comprising" and "wherein." Moreover, in the following claims, the terms "first," "second," and "third," etc. are used merely as labels, and are not intended to impose numerical requirements on their objects or order of execution on their acts.

What is claimed is:

1. A laptop electronic device comprising:
a sensor configured to detect third-party cameras;
one or more processors;
a data storage device having executable instructions accessible by the one or more processors;
wherein, responsive to execution of the instructions, the one or more processors configured to:
monitor an environment for the third-party cameras based on data collected from the sensor; and
provide a remedial action in response to detecting at least one of the third-party cameras.

2. The laptop electronic device of claim 1, wherein the one or more processors are further configured to:
obtain context data related to at least one of a user or the environment; and
activate the sensor configured to detect the third-party cameras based on the context data obtained.

3. The laptop electronic device of claim 1, wherein the sensor is a first sensor, and the one or more processors are further configured to:
obtain context data related to at least one of a user or the environment; and
activate a second sensor configured to detect the third-party cameras based on the context data obtained.

4. The laptop electronic device of claim 1, wherein the one or more processors are further configured to:
obtain context data related to at least one of a user or the environment; and
vary a rate by which the sensor obtains data based on the context data obtained.

5. The laptop electronic device of claim 1, wherein the sensor is configured to detect at least one of infrared reflection, a field of infrared illumination, a laser painting of scenes from a three-dimensional depth map sensor, or flicker from strobed illumination.

6. The laptop electronic device of claim 1, wherein to provide the remedial action comprises displaying an alert on a display of the laptop electronic device.

7. The laptop electronic device of claim 6, wherein the alert includes a location of a third-party camera.

8. The laptop electronic device of claim 1, wherein to provide the remedial action comprises alerting a user via at least one of a visual stimulus or an auditory stimulus.

9. The laptop electronic device of claim 1, wherein to provide the remedial action comprises preventing a user of the laptop electronic device from entering information into the laptop electronic device.

10. A method, comprising:
under control of one or more processors including program instructions to:
monitor, with a sensor, an environment of a laptop electronic device for third-party cameras based on data collected from the sensor; and
provide a remedial action in response to detecting at least one of the third-party cameras.

11. The method of claim 10, wherein under control of the one or more processors including program instructions to:
obtain context data related to at least one of a user or the environment; and
activate the sensor configured to detect the third-party cameras based on the context data obtained.

12. The method of claim 10, wherein under control of the one or more processors including program instructions to:
obtain context data related to at least one of a user or the environment; and
activate a second sensor configured to detect the third-party cameras based on the context data obtained.

13. The method of claim 10, wherein under control of the one or more processors including program instructions to:
obtain context data related to at least one of a user or the environment; and
vary a rate by which the sensor obtains data based on the context data obtained.

14. The method of claim 10, wherein to provide the remedial action comprises displaying an alert on a display of the laptop electronic device.

15. The method of claim 10, wherein to provide the remedial action comprises alerting a user via at least one of a visual stimulus or an auditory stimulus.

16. The method of claim 10, wherein to provide the remedial action comprises preventing a user of the laptop electronic device from entering information into the laptop electronic device.

17. A computer program product comprising a non-signal computer readable storage medium comprising computer executable code to automatically;
monitor, with a sensor, an environment of a laptop electronic device for third-party cameras based on data collected from the sensor; and
provide a remedial action in response to detecting at least one of the third-party cameras.

18. The computer program product of claim 17, wherein the computer executable code to automatically:
obtain context data related to at least one of a user or the environment; and
activate the sensor configured to detect the third-party cameras based on the context data obtained.

19. The computer program product of claim 17, wherein the computer executable code to automatically:
obtain context data related to at least one of a user or the environment; and
activate a second sensor configured to detect the third-party cameras based on the context data obtained.

20. The computer program product of claim 17, wherein the computer executable code to automatically:
obtain context data related to at least one of a user or the environment; and
vary a rate by which the sensor obtains data based on the context data obtained.
